(19) United States
(12) Patent Application Publication
(10) Pub. No.: US 2017/0161804 A1
(43) Pub. Date: Jun. 8, 2017

(54) Auto Navigation Destination (A.N.D.)

(71) Applicant: Sheetal Shefali Verma, Mount Pleasant, SC (US)

(72) Inventor: Sheetal Shefali Verma, Mount Pleasant, SC (US)

(21) Appl. No.: 15/396,585

(22) Filed: Dec. 31, 2016

(51) Int. Cl. G06Q 30/06; G06Q 40/02

(52) U.S. Cl. CPC G06Q 30/0601; G06Q 40/025

(57) ABSTRACT

Auto Navigation Destination (A.N.D.) is a web-based application designed to reform the car purchasing process. In view of its full scale of implications upon gaining a non-provisional utility patent, A.N.D. will allow users to become more informed consumers as they retrieve their credit scores and identify the reasonable corresponding interest rates through built in features. They can then continue to the facet that allows them to review the inventory and purchase prices of any desired vehicles offered at dealerships locally and across the country, at which time they can directly contact on site representatives through video, audio, and/or text options and potentially purchase desired vehicles at reasonable prices through an online platform. In this way, individuals will have the opportunity to view the full range of their dealership options and purchase their ideal vehicles at the best possible rates, thereby fueling the auto industry through more feasible consumerism.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING

Not Applicable

### BACKGROUND OF THE INVENTION

Auto Navigation Destination (A.N.D.) is a software application intended to improve the process of purchasing an automobile, which defines its presence within the auto and technology fields. Specifically, A.N.D. will facilitate individual acquisition of a vehicle by allowing an informed and financially aware survey of inventories beyond local markets. Although there have been recent car dealerships and online platforms that have been developed with their express focus on providing consumers with the most financially reasonable offers, there remains a heightened degree of reliance that buyers have to place on the car salesman and local markets. However, with the stable increase in auto sales since the recent recovery from the 2008 recession and satisfaction of bailout funds extended to the auto industry following this period, along with lowered gasoline prices and the preference for private transportation, there seems to be limited competition in the lowering of auto prices amongst community dealerships. As a result, consumers are forced to compromise to greater degrees than the dealer, leaving the consumer with the impression of having to purchase desired vehicles at still somewhat escalated prices and interest rates due to the lack of other viable options.

### BRIEF SUMMARY OF THE INVENTION

Auto Navigation Destination (A.N.D.) is aimed at modernizing the car buying process by unhinging consumers to the non-existent bargains available at their local auto dealerships. A.N.D. will deliver a comprehensive purchasing method that allows consumers to identify their credit score, the range of rational and respective interest rates, and virtually communicate directly with car dealerships within and beyond their local markets. Essentially, through the technologies integrated in A.N.D., consumers will be able to safely and preparedly browse the inventories of dealerships through the country, thereby heightening competition and bypassing community monopolies to secure their most ideal vehicles at the most affordable prices.

### BRIEF DESCRIPTION OF DRAWINGS

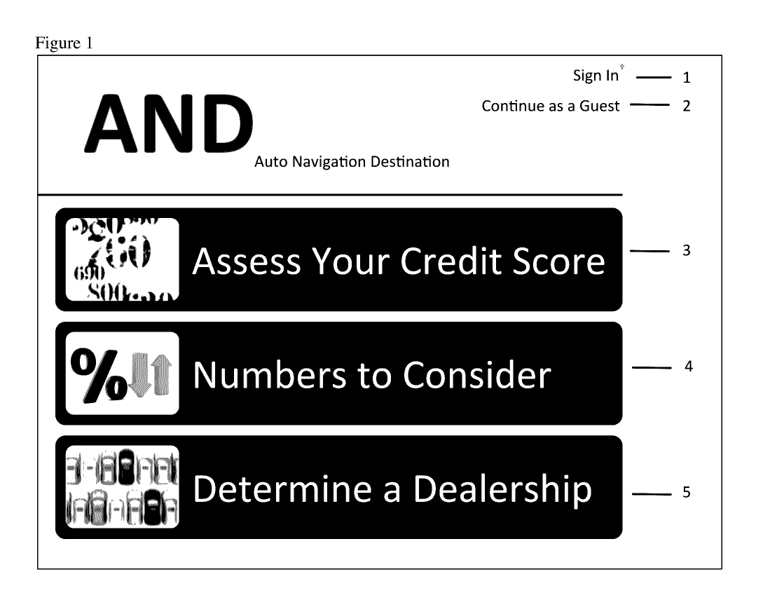

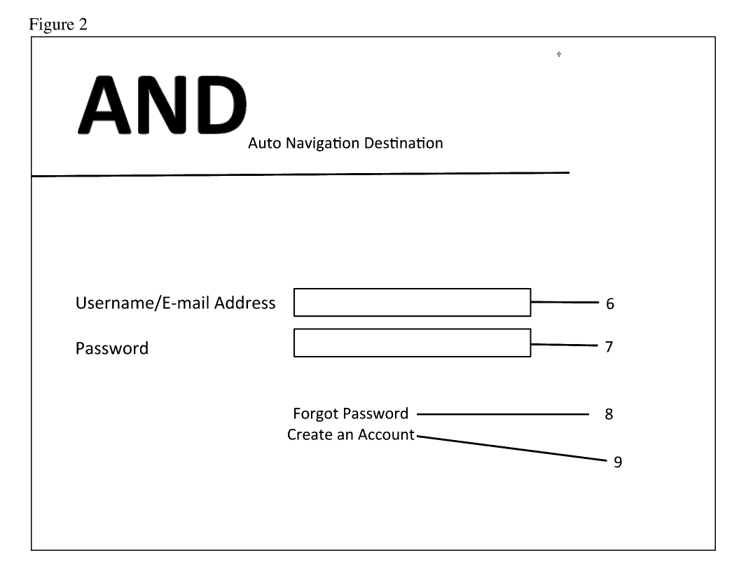

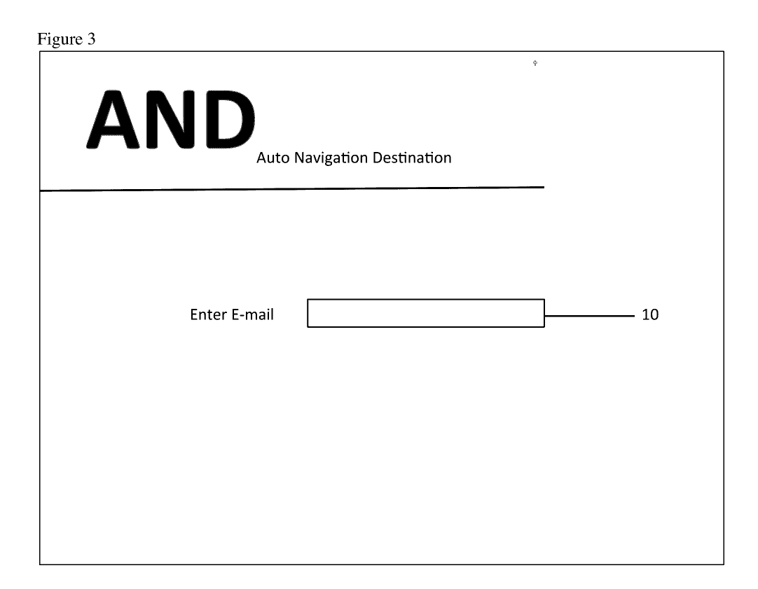

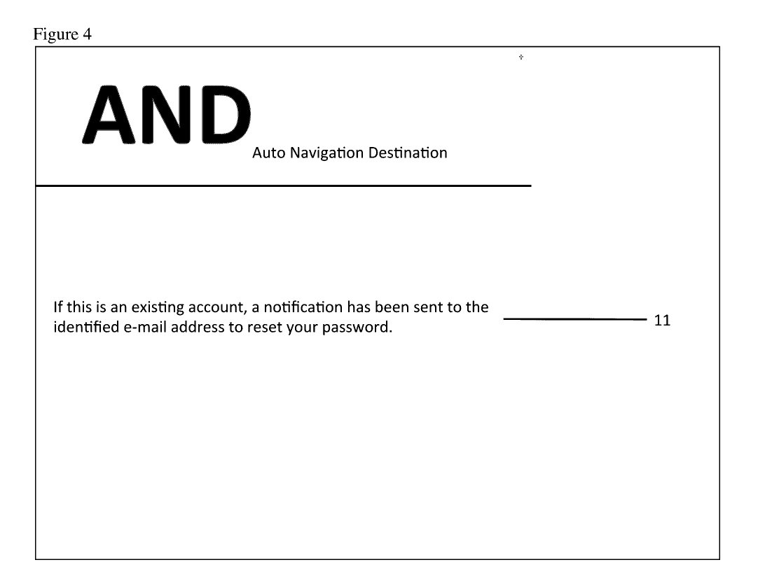

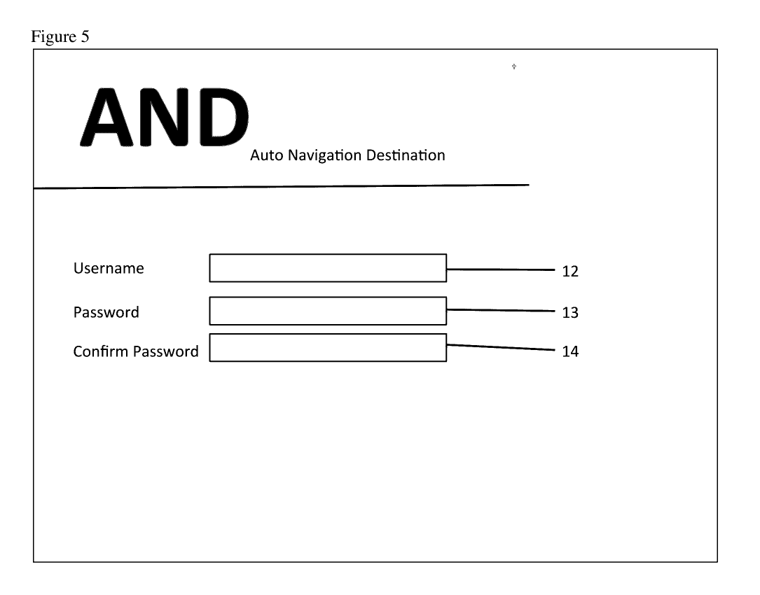

The included images provide a visual overview of the Auto Navigation Destination website and it's utility. In FIG. 1, there is a portrayal of what the homepage of A.N.D. will display. Specifically, it can be noted that individuals will have the opportunity to sign in to an existing account (1) or employ the functions of the site as a guest (2). Incorporated in this image are the services made available by A.N.D, which include the credit score retrieval (3), interest rate calculation (4), and auto dealership search processes (5). In the natural order of the A.N.D. experience as a routine user, FIG. 2 pictures the sign-in steps for the site, which will simply require customers' input of their usernames/email addresses (6) and their respective passwords (7). If customers forger their passwords, they will have the opportunity to have them retrieved by selecting the “Forgot Password” link (8), which will lead them to subsequent pages where they can enter their e-mail address as shown in FIG. 3 (10) and receive confirmation of the password being sent to that e-mail account as displayed FIG. 4 (11). Similarly, if consumers wished to create an account, they would select that option, which is included in image 2 (9), and as shown in FIG. 5, enter their email address as their username (12) and determine and confirm a password (13 and 14 respectively).

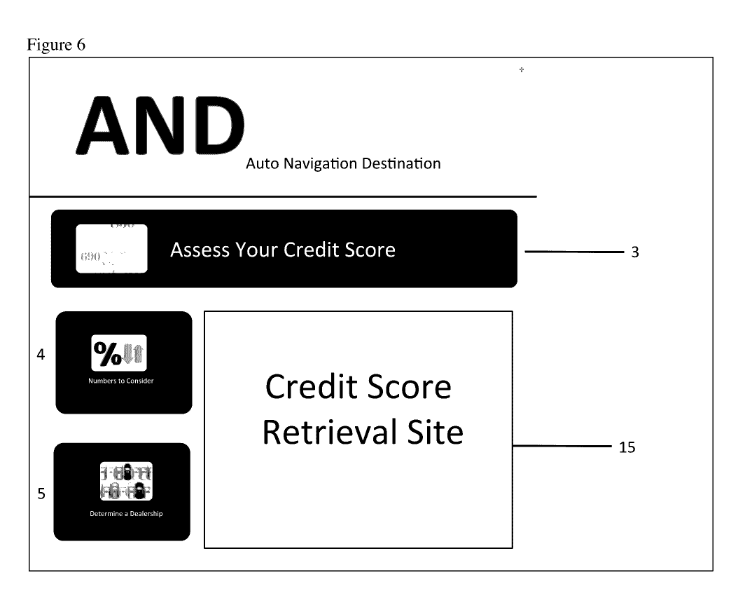

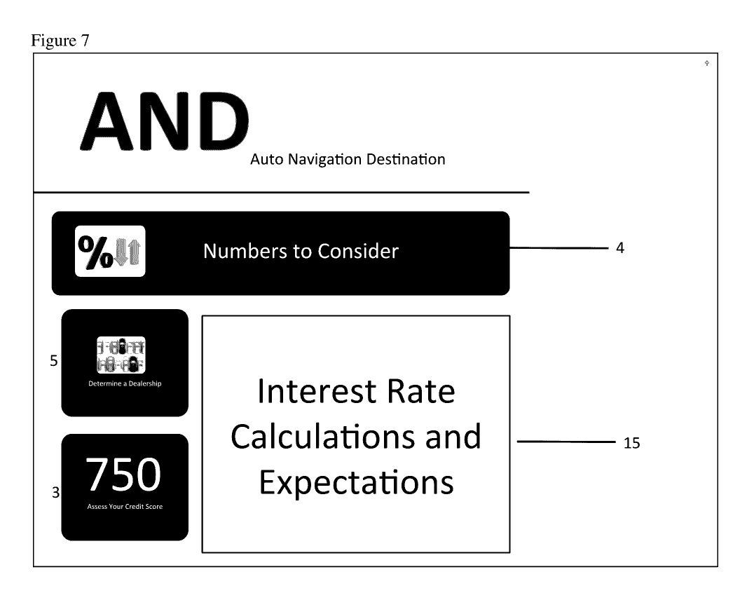

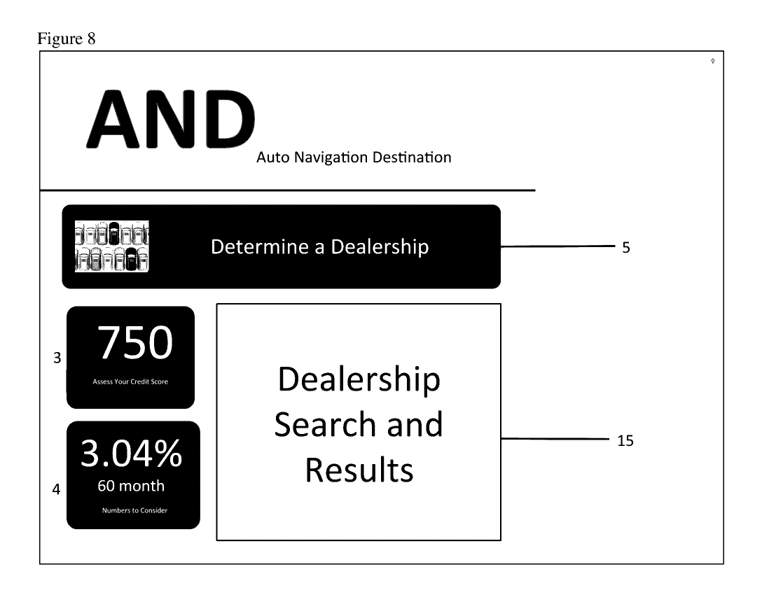

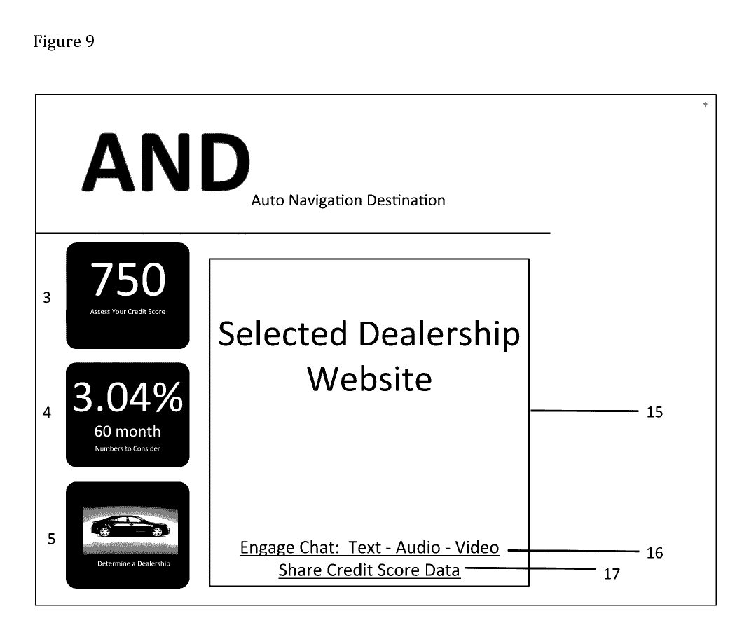

In FIG. 6, the process of use concerning the primary purpose of A.N.D. is visually described in it's first stage as it is shown how the user can select the credit score assessment bar (3) to have the an operable pre-existing credit score platform made accessible in the mainframe of the screen (15). Subsequently, their credit score and that of any co-buyer/co-signers, if desired, would be displayed in its relative square (3) as the user selects the numbers to consider square in FIG. 6 (4) to have their likely interest rate figured in the mainframe in FIG. 7, with as an existing calculation site becoming available (15). When the dealership determination square (5) in FIG. 7 is selected, it can be seen that the interest rate calculated for users will be displayed in its respective square (4) as an existing search engine tailored to dealership identifications is loaded into the mainframe (15) in FIG. 8. Once a dealership is chosen from the users' search, it will be appear in its designated square (5) and the respective dealer's site will automatically display in the mainframe of the site (15) with options for users to browse the existing site and engage in text, audio, and/or video chats (16), which is shown in FIG. 9. In FIG. 9, it can also be seen that individuals can share with the selected dealership's representative their official credit score information as well as that of any co-signers/co-buyers by selecting the ‘Share Credit Score Data’ link (17). It is at this time that users would have the opportunity to discuss in detail the presented inventory and purchase/delivery specifics.

### DETAILED DESCRIPTION OF THE INVENTION

Auto Navigation Destination (A.N.D.) is an incorporative software that will transform the vehicle purchasing process. The design of A.N.D. is intended to be a web-based application that integrates existing web based credit score, interest rate, and online communication services in an innovative and convenient format that specifically meets the needs of auto consumers. (It is notable that these service providers are not exclusively named as any such arrangements would be contingent upon permission being granted by such established entities). To utilize this site, an individual can establish an account that can store and retrieve information across sessions, or they can employ the site for singular sessions as a guest with the all the same benefits. In the first phase, which is optional, the individual can select the Assess Your Credit Score tab, which will upload one of the traditional credit score platforms to the A.N.D. web page for the completion of a credit history review through various prompts. At the conclusion of this step, the credit score will be displayed in one area of the screen and allow access to its detailed content whenever selected during the session. There would also be a built opportunity under this function for an individual to have the credit score of a potential co-signer/co-buyer displayed along with his/her own if that individual completed the credit score assessment process as well under the primary car seeker's account. The retrieval of the individual's credit score, though optional, could have a more positive influence on the accuracy and preparedness of their negotiation as they move into the next two phases.

In the second stage of A.N.D., individuals will be able to input their credit score in a pre-existing interest calculator, which will appear on the A.N.D. site when the Numbers to Consider option is selected. Based on the credit score, type of loan being sought, and the principal amount expected (how much they project they will be borrowing), they can gain an understanding of what they will most likely be paying monthly and how much of what is due will be allocated for interest. Additionally, individuals will have the opportunity to modify the factors included in the calculation, such as the information of a co-signer to be combined with the primary owner's status. Also, there are adjustments that could be made for interest rates that must be determined, such as considerations of the trade in value of cars that are in the consumers' possession. Much like phase one, this phase concerning interest rate calculations can be disregarded, or consumers can gain a more specific idea of what to anticipate in this respect by reviewing the potential interest rates provided on the respective, calculated charts. The related details would then be displayed beneath the individuals credit score if available. Following this calculative phase, individuals would continue to the final feature of A.N.D.

The third stage of A.N.D. allows consumers to browse the dealerships that have accounts with A.N.D. based on various search criteria, including but not limited to location, brand, new vehicles, used vehicles, etc. Once a dealership is selected, individuals can review the inventory and prices, and subsequently, they can initiate Internet based video, audio, or text chat through an existing web communication provider with a representative at the dealership site, which can be modified at any based on the existing online communication providers capacities. Through enabling the array of interactivity, the consumer will be able to discuss and/or view the advertised vehicles of interest and share their official credit score information along with that of any co-signers/co-buyers is applicable. If an agreeable sales price is not offered, individuals could continue their search through contacting other dealerships listed, conveying their interest in completing a vehicle purchase, and sharing their credit information without having this data run multiple times and having a negative impact on their credit standing through such frequent inquiries in a short time period. However, if an optimal contract is proposed, individuals will have the option of discussing means of completing paperwork with the dealership representative. It is important to note that in devising this agreement, it will be at the discretion of the individuals and dealerships jointly how auto trade-ins and auto deliveries and/or transports will be managed.

1. A.N.D. is fundamentally structured to innovate and improve the car buying process to benefit consumers.
As mentioned, they will have credit score and interest rate features at their disposal, which will ideally allow them to become more informed buyers as they navigate the vehicles available at multiple dealerships.
Yet, the multiple features provided by A.N.D. are optional. If an individual does not wish to input their information and respond to the subsequent inquiries to retrieve their credit score, they can bypass this phase of the process.
Similarly, they potential car buyer can continue to the secondary phase, at which time they can obtain a vague but typical interest rate without his/her specific credit score or one based on the retrieval of their credit score through alternate means. However, individuals can decide to forego this feature as well.
Whether the a given consumer chooses to utilize both, one, or neither of the credit score and interest rate calculation function, the hallmark of A.N.D. remains as the video/audio/text chat features that will allow consumers to communicate with dealerships locally and/or long distance and acquire their desired vehicles at the most reasonable price offered in real time without the need for any immediate travel inconveniences.

2. Ultimately, the introduction of this application to the car purchasing process will not only benefit buyers but will also encourage growth in the auto industry as the feat of securing a new car become more financially feasible.
In turn, we can then expect economic growth to occur as demands in this critical sector increase, which can assert positive impact on the industry and standards of transportation as a whole.
